(19) United States
(12) Patent Application Publication
(10) Pub. No.: US 2015/0156125 A1
(43) Pub. Date: Jun. 4, 2015

(54) METHOD FOR MANAGING A QUEUE BASED ON A CHANGE RATE PARAMETER

(71) Applicants: Martin Skarve, Enebyberg (SE); Anders Jonsson, Taby (DE)

(72) Inventors: Martin Skarve, Enebyberg (SE); Anders Jonsson, Taby (DE)

(73) Assignee: Optis Cellular Technology, LLC

(21) Appl. No.: 14/412,388

(22) PCT Filed: Jul. 5, 2012
(86) PCT No.: PCT/SE2012/050784

§ 371 Date: Dec. 31, 2014

(51) Int. Cl. H04L 12/823; H04W 28/02

(52) U.S. Cl. CPC H04L 47/32; H04W 28/0231

(57) ABSTRACT

It is presented a queue manager arranged to manage a queue associated with a single radio access bearer of a mobile communication system. The queue manager comprises: a queue detector arranged to provide a change rate parameter indicating a rate of change of a size of the queue; a discard determiner arranged to determine a first discard condition based on the change rate parameter; and a packet discarder arranged to discard a packet in the queue when the first discard condition is satisfied. Corresponding method, radio base station, radio network controller and user equipment are also presented.

### TECHNICAL FIELD

The invention relates to a queue manager and corresponding method, radio base station, radio network controller and user equipment. In particular, it is related to manage a queue associated with a single radio access bearer.

### BACKGROUND

In a WCDMA (Wideband Code Division Multiple Access) system, the RAN (Radio Access Network) normally comprises an RNC (Radio Network Controller) and one or more RBSs (Radio Base Stations), where the RBS is responsible for transmitting data over the air interface. A transport network congestion control algorithm (flow control algorithm) is used to ensure that an appropriate amount of user data is available in queues of the RBS for scheduling.

In the traditional transport network congestion control algorithm for downlink traffic, the RNC shapes the traffic down to the RBS in order to keep a constant (measured in time) or a certain amount (measured in bytes or bits) of user data buffered in the RBS. The RNC shaping of traffic is based on capacity allocations sent from the RBS.

Alternatively, the RBS is more or less the only RAN node (not counting transmission nodes) with user data buffered. The user data traffic volume in the RBS buffer, as well as TN node buffers are controlled by introducing a controlled packet loss scheme on user data. The algorithm used to control a buffer introducing packet losses in a data transport system is known as Active Queue Management (AQM). The AQM algorithms are most often used in data routers and nodes where traffic from more than one user uses the same finite queue. In a limited number of scenarios, AQM is used on queues for only one user or one radio access bearer.

The management of queues in AQM is not trivial. The queue should not be too small, as discards are taxing on higher level protocols. Moreover, the queue should not be too large as this may cause undesired retransmissions.

### SUMMARY

It is thus an object to find a better way to manage queue discards of queues associated with a single radio access bearer.

According to a first aspect, it is presented a queue manager arranged to manage a queue associated with a single radio access bearer of a mobile communication system. The queue manager comprises: a queue detector arranged to provide a change rate parameter indicating a rate of change of a size of the queue; a discard determiner arranged to determine a first discard condition based on the change rate parameter; and a packet discarder arranged to discard a packet in the queue when the first discard condition is satisfied.

The discard determiner may further be arranged to determine a second discard condition, wherein the second discard condition is that an age of an oldest packet in the queue is greater than an age threshold and that the size of the queue is greater than a size threshold; and the packet discarder is arranged to discard a packet in the queue when the first discard condition and the second discard condition are both satisfied.

The change rate parameter may comprise a quotient between an output data rate of the queue and an input data rate of the queue.

The first discard condition may comprise the determination that the following is true:

$${( \frac{rate\_in}{rate\_out} )}^{k} > y$$

where rate_out denotes the output data rate of the queue, rate_in denotes the input data rate of the queue, k denotes a first configurable constant and y denotes a second configurable constant.

The discard determiner may be arranged to determine the first discard condition using a calculation of a prohibit time based on the change rate parameter, such that the first discard condition fails to be satisfied when less time than the prohibit time has passed since the most recent previous discard in the queue.

The discard determiner may be arranged to calculate the prohibit time according to:

$$t\_prohibit = {( \frac{rate\_out}{rate\_in} )}^{j} \cdot c$$

where t_prohibit denotes the prohibit time, rate_out denotes the output data rate of the queue, rate_in denotes the input data rate of the queue, j denotes a third configurable constant and c denotes a fourth configurable constant.

The discard determiner may be arranged to limit the prohibit time by a minimum prohibit time and a maximum prohibit time.

The packet discarder may be arranged to discard a packet by corrupting the packet.

The packet discarder may be arranged to discard a packet by removing the packet from the queue.

The queue manager may be arranged to manage a plurality of queues analogously but independently, wherein each queue is associated with a single radio access bearer.

At least two queues may be associated with a single radio access bearer.

According to a second aspect it is presented a radio base station comprising a queue manager according to the first aspect.

According to a third aspect, it is presented a radio network controller comprising a queue manager according to the first aspect.

According to a fourth aspect, it is presented a user equipment comprising a queue manager according to the first aspect.

According to fifth aspect, it is presented a method for managing a queue associated with a single radio access bearer of a mobile communication system. The method is executed in a queue manager and comprises the steps of: obtaining a change rate parameter indicating a rate of change of a size of the queue; determining a first discard condition based on the change rate parameter; and discarding a packet in the queue when the first discard condition is satisfied.

The method may further comprise: determining a second discard condition to be that an age of an oldest packet in the queue is greater than an age threshold and that the size of the queue is greater than a size threshold; and the step of discarding a packet may comprise discarding a packet in the queue when the first discard condition and the second discard condition are both satisfied.

In the step of obtaining a change rate parameter, the change rate parameter may comprise a quotient between an output data rate of the queue and an input data rate of the queue.

The step of determining a first discard condition may comprise determining that the following is true:

$${( \frac{rate\_in}{rate\_out} )}^{k} > y$$

where rate_out denotes the output data rate of the queue, rate_in denotes the input data rate of the queue, k denotes a first configurable constant and y denotes a second configurable constant.

The step of determining a first discard condition may comprise calculating a prohibit time based on the change rate parameter, whereby the first discard condition fails to be satisfied when less time than the prohibit time has passed since the most recent previous discard in the queue.

The prohibit time may be calculated according to:

$$t\_prohibit = {( \frac{rate\_out}{rate\_in} )}^{j} \cdot c$$

where t_prohibit denotes the prohibit time, rate_out denotes the output data rate of the queue, rate_in denotes the input data rate of the queue, k denotes a third configurable constant and c denotes a fourth configurable constant.

The prohibit time may be limited by a minimum prohibit time and a maximum prohibit time.

Any feature of the first, second, third, fourth and fifth aspect may, where appropriate, be applied to any other of these aspects.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating an mobile communication system where embodiments presented herein can be applied;

FIG. 2 is a schematic diagram illustrating a queue as used in the mobile communication system of FIG. 1;

FIGS. 3A-B are flow charts illustrating methods according to embodiments which can be executed in the queue manager of FIGS. 1 and 3; and

FIG. 4 is a schematic diagram illustrating functional modules of a queue manager of the mobile communication system of FIG. 1.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

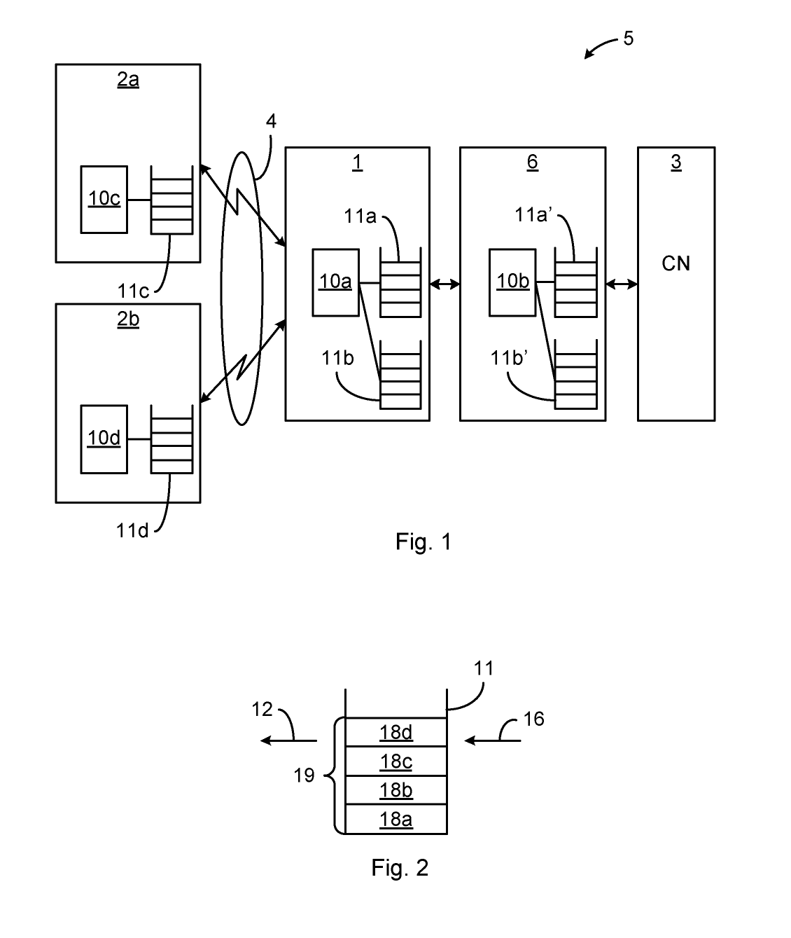

FIG. 1 is a schematic diagram illustrating an mobile communication system 5 where embodiments presented herein can be applied. The mobile communications system 5 comprises a core network 3 and one or more radio base stations 1, here in the form of Node Bs 1, also known as NBs. The radio base stations 1 could also be in the form of evolved Node Bs, BTSs (Base Transceiver Stations) and/or BSSs (Base Station Subsystems). The radio base stations 1 provide radio connectivity to a plurality of mobile communication terminals 2a-b. The term mobile communication terminal is also known as user equipment, mobile terminal, user terminal, user agent, etc.

The mobile communication system 5 can e.g. comply with any one or a combination of W-CDMA (Wideband Code Division Multiplex), LTE (Long Term Evolution), EDGE (Enhanced Data Rates for GSM Evolution, GPRS (General Packet Radio Service)), CDMA2000 (Code Division Multiple Access 2000), etc. or any future mobile communication standard, as long as the principles described hereinafter are applicable.

The communication between each one of the mobile communication terminals 2a-b and the radio base stations 1 occurs over a wireless radio interface 4. The mobile communication terminals 2a-b each have one or more radio access bearers established for communication over the wireless radio interface 4, when communication is active.

The radio base stations 1 are optionally controlled by a radio network controller node (RNC) 6. The radio base stations 1 are also connected, via the RNC 6 if there is one provided, to a core network 3 for connectivity to central functions and other networks.

Each radio base station 1 comprises queues 11a-b. Each one of the queues 11a-b is associated with a single radio access bearer. In this example, a first queue 11a is associated with downlink communication over a first radio access bearer to the first mobile communication terminal 2a. Analogously, a second queue 11b is associated with downlink communication over a second radio access bearer to the second mobile communication terminal 2b. The radio base station 1 also comprises a queue manager boa to manage the queues 11a-b.

Optionally, the RNC 6 also comprises queues 11a′-b′ queues corresponding to the queues 11a-b of the radio base station 1. Hence, each one of the queues 11a′-b′ is associated with a single radio access bearer. In this example, a first queue 11a′ is associated with downlink communication over the first radio access bearer to the first mobile communication terminal 2a. Analogously, a second queue 11b′ is associated with downlink communication over the second radio access bearer to the second mobile communication terminal 2b. The RNC 6 also comprises a queue manager bob to manage the queues 11a′-b′.

Similarly for uplink communication, the mobile communication terminals 2a-b each comprises respective queues 11c-d. In other words, the first mobile communication terminal 2a comprises a queue 11c for a first uplink radio access bearer. The queue 11c is controlled by a queue manager 10c. Analogously, the second mobile communication terminal 2b comprises a queue 11d for a second uplink radio access bearer. The queue 11d is controlled by a queue manager 10d. Each mobile communication terminal 2a-b can have more queues if there are more uplink radio access bearers, controlled by a queue manager.

It is to be noted that there could be several queues associated with a single radio access bearer, but each queue is only associated with a single radio access bearer.

FIG. 2 is a schematic diagram illustrating a queue 11 as used in the mobile communication system 5 of FIG. 1. All respective queues 11a-d, 11a′-b′ are here represented by a single queue 11 as they all function according to the same principle. At any one time, the queue 11 comprises zero or more packets 18a-d. In this example, the queue has four packets 18a-d. A packet can for example be a protocol data unit (PDU). A size of the queue is the same as the number of packets in the queue, whereby a size 19 of the queue in this instance is four. New packets arrive to the queue 11 at an input data rate 16 and packets are processed and removed from the queue 11 at an output data rate 12. The queue 11 is a first in first out (FIFO) queue for packets to be sent over the wireless radio interface 4 (FIG. 1).

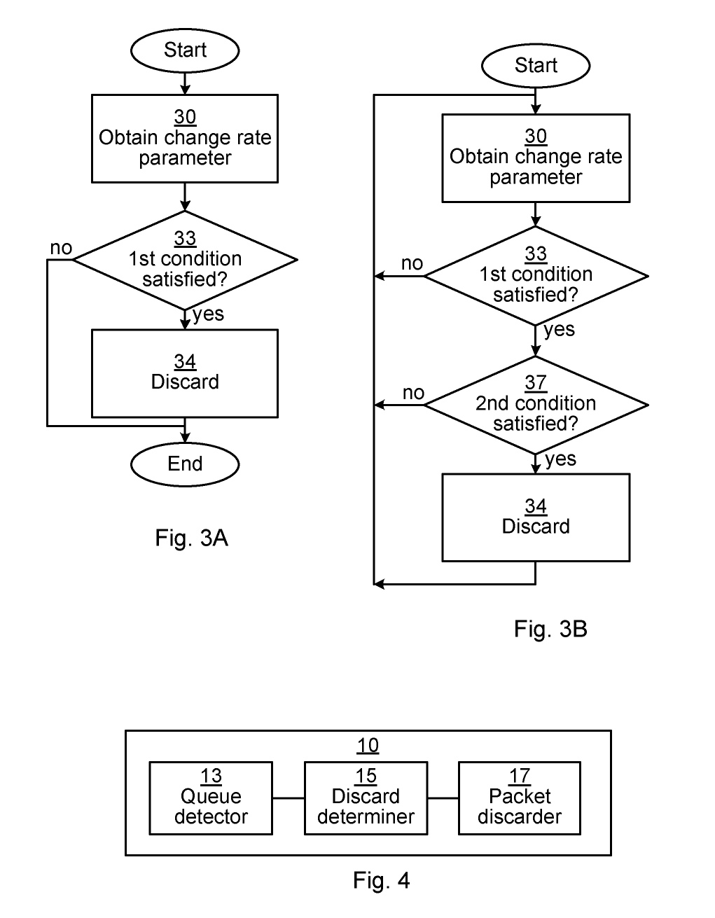

FIGS. 3A-B are flow charts illustrating methods according to embodiments which can be executed in the queue manager of FIGS. 1 and 4 to manage an associated queue. First, the method illustrated in FIG. 3A will be described.

In an initial obtain change rate parameter step 30, a change rate parameter is obtained. The change rate parameter indicates a rate of change of a size of the queue.

The change rate parameter can comprise a quotient between the output data rate of the queue and the input data rate of the queue.

In a conditional 1^{st} condition satisfied step 33, a first discard condition is determined based on the change rate parameter. If the first discard condition is not satisfied, the method ends. Otherwise, if the first discard condition is satisfied, the method continues to a discard step 34.

In one embodiment, the first discard condition comprises determining that the following is true:

$${( \frac{rate\_in}{rate\_out} )}^{k} > y$$

where rate_out denotes the output data rate of the queue, rate_in denotes the input data rate of the queue, k denotes a first configurable constant and y denotes a second configurable constant. In this way, it is determined that when the queue change rate is such that it decreases in size more than a given value, the first discard condition is satisfied and a discard is not ruled out.

Optionally, the first discard condition can also comprise the sub-condition of prohibit time. The prohibit time is then calculated based on the change rate parameter, and the first discard condition fails to be satisfied when less time than the prohibit time has passed since the most recent previous discard in the queue. In one embodiment, the prohibit time is calculated according to:

$$t\_prohibit = {( \frac{rate\_out}{rate\_in} )}^{j} \cdot c$$

where t_prohibit denotes the prohibit time, rate_out denotes the output data rate of the queue, rate_in denotes the input data rate of the queue, k denotes a third configurable constant and c denotes a fourth configurable constant.

Optionally, the prohibit time is limited by a minimum prohibit time and a maximum prohibit time, such that t_prohibit_min≦t_prohibit≦t_prohibit_max, where t_prohibit_min denotes the minimum prohibit time and t_prohibit_max denotes the maximum prohibit time.

For example, t_prohibit_min can be set to the first time period (one estimated round trip time) after the last packet discard was made from the rate calculations. This allows a better capture of the behaviour received as a response to this last packet discard.

In the discard step 34, a packet in the queue is discarded. This can e.g. be performed by removing a packet in the queue or by manipulating a packet in the queue to invalidate it. When a packet is discarded, this is handled by higher level protocols, such as retransmission using RLC (Radio Link Control) or TCP (Transmission Control Protocol) in the case of IP (Internet Protocol).

By using the rate of change of a size of the queue in the determination whether to discard a packet, the algorithm is automatically adapted to larger variations in outgoing rate. These variations can e.g. be due to changing radio conditions due to the mobile communication terminal moving or by other mobile communication terminals establishing or dropping communication in the same cell. In this way, the risk is reduced of the queue becoming empty due to too little data there being too much data in the queue, causing the RLC timing out and unnecessary RLC retransmissions.

FIG. 3B illustrates a method according to one embodiment. The steps of method 3A which have equivalents in the method illustrated in FIG. 3B will not be described again.

In this embodiment, if the first discard condition is satisfied, the method continues to a conditional 2^{nd} condition satisfied step 37. If the first discard condition is not satisfied, the method optionally returns to the obtain change rate parameter step 30.

In the conditional 2^{nd} condition satisfied step 37, a second discard condition is determined. The second discard condition comprises two sub-conditions. The first sub-condition is that an age of an oldest packet in the queue is greater than an age threshold. The second sub-condition is that the size of the queue is greater than a size threshold.

If, and only if both the first and second sub-conditions are true, the second discard condition is satisfied and the method continues to the discard step 34. On the other hand, if the second discard condition is not satisfied, the method ends. Otherwise, if the second discard condition is satisfied, the method continues to the discard step 34.

After the discard step, the method optionally returns to the obtain change rate parameter step 30 to allow continued management of the queue state.

It is to be noted that the order in which the evaluation of the first and second discard conditions are placed in the method is not important; the second discard condition could equally well be evaluated before the first discard condition.

FIG. 4 is a schematic diagram illustrating functional modules of a queue manager 10 of the mobile communication system of FIG. 1. All respective queue managers 10a-d are here represented by a single queue manager 10. The modules of the queue manager 10 can be implemented using hardware such as DSPs (Digital Signalling Processors) and Application Specific Integrated Circuits (ASICs), and/or software executing in a processor. The modules correspond to steps of the methods illustrated in the flow charts of FIGS. 3A-B.

The queue manager 10 can, in parallel, manage a plurality of queues analogously but independently. For example, when implemented in a radio base station, a queue manager can manage many queues. It is to be noted that several queues can be associated with a single radio access bearer but a each queue is only associated with a single radio access bearer.

A queue detector 13 is arranged to provide a change rate parameter indicating a rate of change of a size 19 of the queue. The queue detector 13 corresponds to the obtain change rate parameter step 30.

A discard determiner 15 is arranged to determine a first discard condition based on the change rate parameter. The discard determiner 15 corresponds to the 1^{st} condition satisfied step 33 and the 2^{nd} condition satisfied step 37.

A packet discarder 17 arranged to discard a packet in the queue when the first discard condition is satisfied. The packet discarder 16 corresponds to the discard step 34.

The invention has mainly been described above with reference to a few embodiments. However, as is readily appreciated by a person skilled in the art, other embodiments than the ones disclosed above are equally possible within the scope of the invention, as defined by the appended patent claims.

1. A queue manager arranged to manage a queue associated with a single radio access bearer of a mobile communication system, the queue manager comprising:
a queue detector arranged to provide a change rate parameter indicating a rate of change of a size of the queue;
a discard determiner arranged to determine a first discard condition based on the change rate parameter; and
a packet discarder arranged to discard a packet in the queue when the first discard condition is satisfied.

2. The queue manager according to claim 1, wherein the discard determiner is further arranged to determine a second discard condition, wherein the second discard condition is that an age of an oldest packet in the queue is greater than an age threshold and that the size of the queue is greater than a size threshold; and the packet discarder is arranged to discard a packet in the queue when the first discard condition and the second discard condition are both satisfied.

3. The queue manager according to claim 1, wherein the change rate parameter comprises a quotient between an output data rate of the queue and an input data rate of the queue.

4. The queue manager according to claim 3, wherein the first discard condition comprises the determination that the following is true:
$${( \frac{rate\_in}{rate\_out} )}^{k} > y$$
where rate_out denotes the output data rate of the queue, rate_in denotes the input data rate of the queue, k denotes a first configurable constant and y denotes a second configurable constant.

5. The queue manager according to claim 3, wherein the discard determiner is arranged to determine the first discard condition using a calculation of a prohibit time based on the change rate parameter, such that the first discard condition fails to be satisfied when less time than the prohibit time has passed since the most recent previous discard in the queue.

6. The queue manager according to claim 5, wherein the discard determiner is arranged to calculate the prohibit time according to:
$$t\_prohibit = {( \frac{rate\_out}{rate\_in} )}^{j} \cdot c$$
where t_prohibit denotes the prohibit time, rate_out denotes the output data rate of the queue, rate_in denotes the input data rate of the queue, j denotes a third configurable constant and c denotes a fourth configurable constant.

7. The queue manager according to claim 5, wherein the discard determiner is arranged to limit the prohibit time by a minimum prohibit time and a maximum prohibit time.

8. The queue manager according to claim 1, wherein the packet discarder is arranged to discard a packet by corrupting the packet.

9. The queue manager according to claim 1, wherein the packet discarder is arranged to discard a packet by removing the packet from the queue.

10. The queue manager according to claim 1, wherein the queue manager is arranged to manage a plurality of queues analogously but independently, wherein each queue is associated with a single radio access bearer.

11. The queue manager according to claim 10, wherein at least two queues are associated with a single radio access bearer.

12.-14. (canceled)

15. A method for managing a queue associated with a single radio access bearer of a mobile communication system, the method being executed in a queue manager and comprising the steps of:
obtaining a change rate parameter indicating a rate of change of a size of the queue;
determining a first discard condition based on the change rate parameter; and
discarding a packet in the queue when the first discard condition is satisfied.

16. The method according to claim 15, further comprising:
determining a second discard condition to be that an age of an oldest packet in the queue is greater than an age threshold and that the size of the queue is greater than a size threshold;
and wherein the step of discarding a packet comprises discarding a packet in the queue when the first discard condition and the second discard condition are both satisfied.

17. The method according to claim 15, wherein in the step of obtaining a change rate parameter, the change rate parameter comprises a quotient between an output data rate of the queue and an input data rate of the queue.

18. The method according to claim 17, wherein the step of determining a first discard condition comprises determining that the following is true:
$${( \frac{rate\_in}{rate\_out} )}^{k} > y$$
where rate_out denotes the output data rate of the queue, rate_in denotes the input data rate of the queue, k denotes a first configurable constant and y denotes a second configurable constant.

19. The method according to claim 17, wherein the step of determining a first discard condition comprises calculating a prohibit time based on the change rate parameter, whereby the first discard condition fails to be satisfied when less time than the prohibit time has passed since the most recent previous discard in the queue.

20. The method according to claim 19, wherein the prohibit time is calculated according to:
$$t\_prohibit = {( \frac{rate\_out}{rate\_in} )}^{j} \cdot c$$
where t_prohibit denotes the prohibit time, rate_out denotes the output data rate of the queue, rate_in denotes the input data rate of the queue, k denotes a third configurable constant and c denotes a fourth configurable constant.

21. The method according to claim 19, wherein the prohibit time is limited by a minimum prohibit time and a maximum prohibit time.

22. A user equipment comprising a queue manager arranged to manage a queue associated with a single radio access bearer of a mobile communication system, the queue manager comprising:
a queue detector arranged to provide a change rate parameter indicating a rate of change of a size of the queue;
a discard determiner arranged to determine a first discard condition based on the change rate parameter; and
a packet discarder arranged to discard a packet in the queue when the first discard condition is satisfied.

23. The user equipment according to claim 22, wherein the discard determiner is further arranged to determine a second discard condition, wherein the second discard condition is that an age of an oldest packet in the queue is greater than an age threshold and that the size of the queue is greater than a size threshold; and the packet discarder is arranged to discard a packet in the queue when the first discard condition and the second discard condition are both satisfied.

24. The user equipment according to claim 22, wherein the change rate parameter comprises a quotient between an output data rate of the queue and an input data rate of the queue.
